(19) United States
(12) Patent Application Publication
(10) Pub. No.: US 2012/0026547 A1
(43) Pub. Date: Feb. 2, 2012

(54) FILE MANAGEMENT SYSTEM

(75) Inventor: Gary Kung, Santa Ana, CA (US)

(73) Assignee: I/O INTERCONNECT, LTD., Santa Ana, CA (US)

(21) Appl. No.: 13/195,096

(22) Filed: Aug. 1, 2011

Related U.S. Application Data
(60) Provisional application No. 61/369,797, filed on Aug. 2, 2010.

(51) Int. Cl. G06F 3/12

(52) U.S. Cl. 358/1.15

(57) ABSTRACT

A method for controlling a host apparatus is provided by the present invention. When the host apparatus receives a sending message from a mobile device, the sending message is scanned by the host apparatus, so as to determine whether or not a requirement command is attached into the sending message. Wherein, a file is attached into the sending message. If the requirement command is attached into the sending message, the method would identify the requirement command. When the requirement command is a print requirement command, the method would make the host apparatus driving a printer connected to the host apparatus to print the file.

### CROSS-REFERENCE TO RELATED APPLICATIONS

The application claims priority of U.S. provisional patent application Ser. No. 61/369,797 filed on Aug. 02, 2010, the contents of which are hereby incorporated by reference.

### FIELD OF THE INVENTION

The present invention relates to a system, and more particularly to a file management system.

### BACKGROUND OF THE INVENTION

Smart phone has more and more development and application dimension recently and become an efficient instrument for the life style of requiring convenient and fast. Generally, taking photo and linking the internet are the necessary basic functions in the smart phone. The common means to operate the smart phone is that the user uses a shoot function to take pictures of people, things, and objects on the go, and saves the pictures in the self mobile phone, even uploads the pictures to the social group website for sharing other people.

Although sharing information through the network is common means, not all information needed to upload and share openly. The instantaneity of some of data, such as text file or picture, has a commercial requirement, not being public on the network. For the commercial requirement, the information may be needed to send to an office or a meeting place immediately. Such the instantaneity cannot be satisfied by the conventional smart phone.

In addition, for dealing with body carrying requirement, the design of the smart phone directs light and thin. The defect of the light and thin design is that the memory of the smart phone is less than the memory of the portable computer or desktop computer. Additionally, the risk of losing the smart phone is higher than the computer. If the user wants to preserve the data saved into the smart phone well, it is rely on the user to backup the data into other storage device, so as to reduce the risk of losing data.

### SUMMARY OF THE INVENTION

Therefore, the present invention is to provide a file management method, for managing files according to a user's requirement.

In addition, the present invention provides a method for on-line printing, for printing a file from a mobile device.

A method for controlling a host apparatus is provided by the present invention. When the host apparatus receives a sending message from a mobile device, the sending message is scanned by the host apparatus, so as to determine whether or not a requirement command is attached into the sending message. Wherein, a file is attached into the sending message. If the requirement command is attached into the sending message, the method would identify the requirement command. When the requirement command is a print requirement command, the method would make the host apparatus driving a printer connected to the host apparatus to print the file.

In one embodiment of the present invention, the sending message is an e-mail, and the file is probably a text file, an image file, a video file, or an audio file.

In addition, when the requirement command is a save requirement command, the method would make the host apparatus to save the file.

Furthermore, when the requirement command is an upload requirement command, the method would make the host apparatus to upload the file to a web site.

From another viewpoint, a method for on-line print is provided by the present invention. First, a sending message is generated according to a user's operating on a mobile device. Then, a print requirement command and a file are attached into the sending message according to the user's operating. In addition, the sending message is transmitted to a host apparatus from the mobile device, so as to make the host apparatus driving a printer to print the file scanning the sending message to obtain the print requirement command.

Since the present invention deals with the file according to a requirement command embedded into the sending message, the present invention can more flexible manage the file. In addition, because the file can attach on the sending message, the present invention can more immediate manage the file.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram of a file management system according to one preferred embodiment of the present invention.

FIG. 2 is a schematic diagram of a host apparatus according to one preferred embodiment of the present invention.

FIG. 3 is a schematic diagram of a printer according to one preferred embodiment of the present invention.

FIG. 4 is a schematic diagram of a mobile device according to one preferred embodiment of the present invention.

FIGS. 5A and 5B are flow charts of a file management method according to one preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

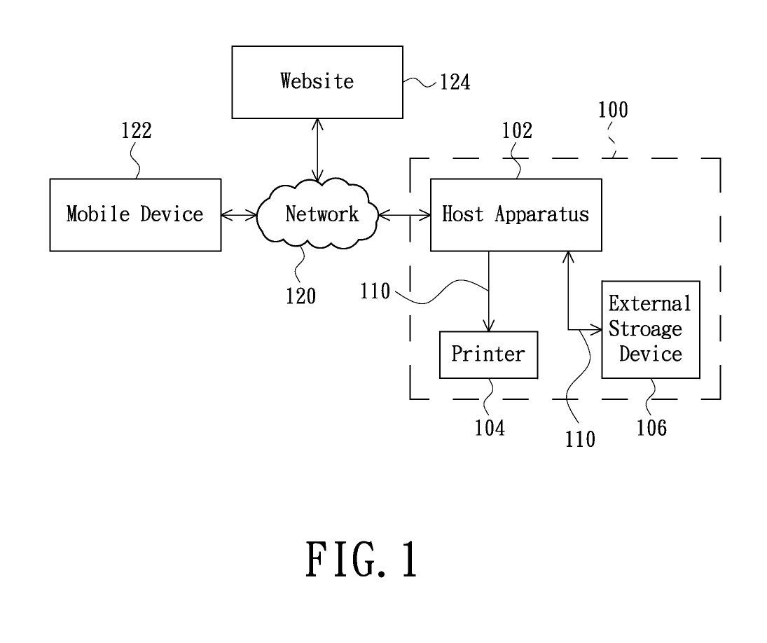

FIG. 1 is a schematic diagram of a file management system according to one preferred embodiment of the present invention. Referring to the FIG. 1, the file management system 100 can linking with a mobile device 122 through a network 120, such as the internet. Furthermore, the file management system 100 also can link with a website 124 through the network 120. In this exemplary embodiment, the file management system 100 has a host apparatus 102 and a printer 104. The host apparatus 102 is probably a desktop computer or a portable computer. In addition, the host apparatus 102 connects to the printer 104 through a data transmission interface 110. In some embodiments, the data transmission interface 110 is a USB interface.

In some embodiments, the host apparatus 102 further connects with an external storage device 106 through the data transmission interface 110. Wherein, the external storage device 106 is probably an external hard-disk driver or an external flash memory device.

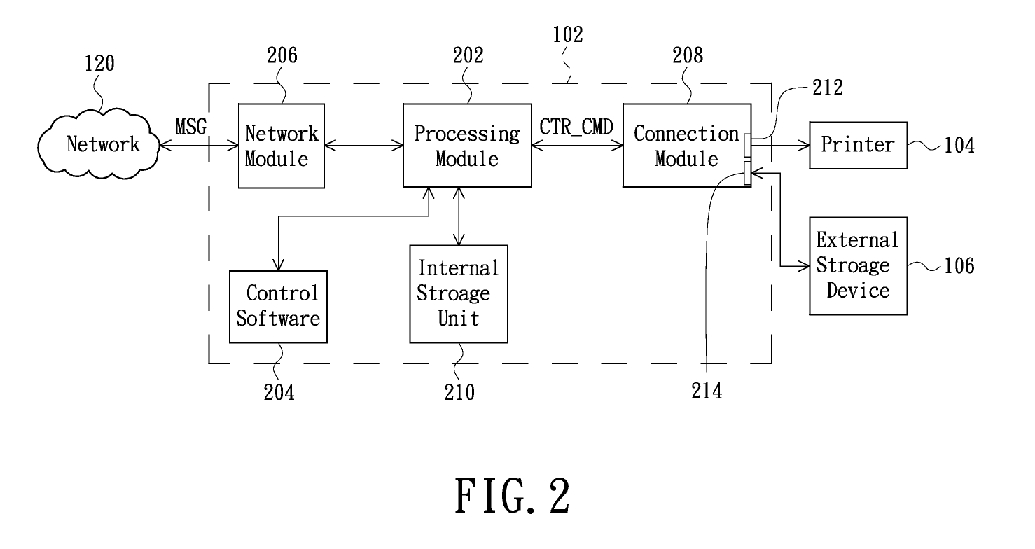

FIG. 2 is a schematic diagram of a host apparatus according to one preferred embodiment of the present invention. Referring to the FIG. 2, the host apparatus 102 comprises a processing module 202 and a control software 204. The control software 204 can be implemented by a program production, such as an application program or a firmware. The processing module 202 can communicate with the control software 204. Additionally, the host apparatus 102 also has a network 206 and a connection module 208. Both the network module 206 and the connection module 208 are coupled with the processing module 202. The network module 206 is probably a network card for linking with the network 120.

In addition, the connection module 208 has at least one connection port, such as the connection ports 212 and 214. In this exemplary embodiment, the connection ports 212 and 214 are probably USB ports. In addition, the host apparatus 102 further comprises a internal storage unit which is coupled with the processing module 202, and configured for providing a store space for the control software 204. The internal storage unit 210 is probably an internal hard-disk driver or a flash memory.

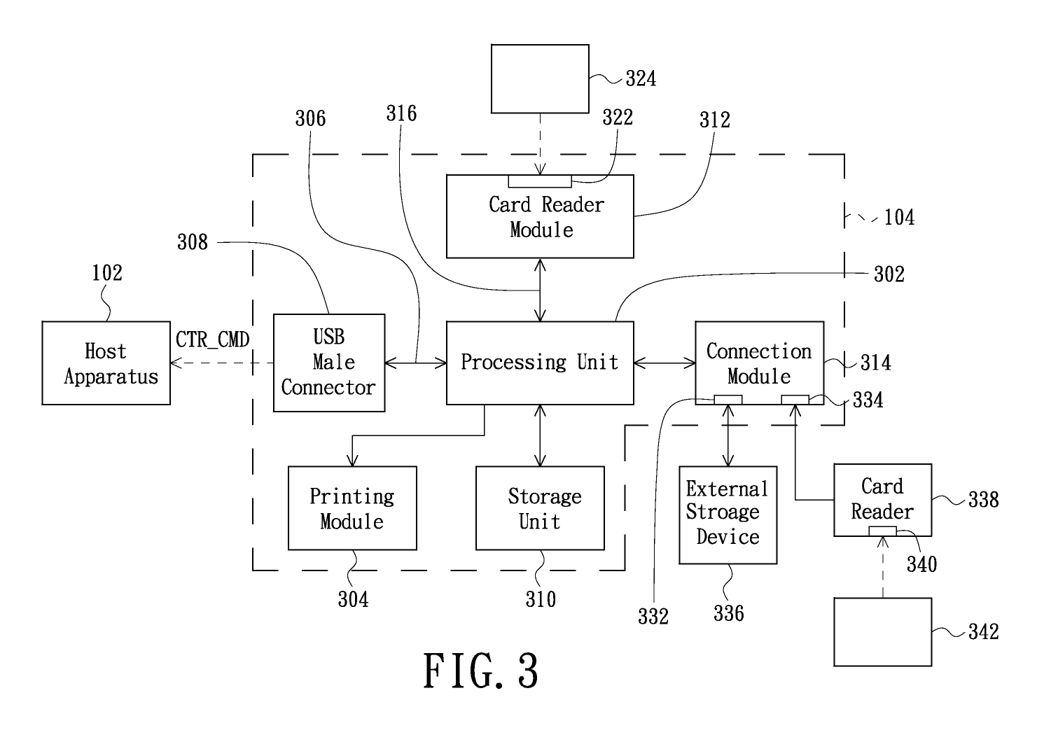

FIG. 3 is a schematic diagram of a printer according to one preferred embodiment of the present invention. Referring to the FIG. 3, the printer 104 comprises a processing unit 302 and a printing module 304. Wherein, the processing unit 302 is coupled to the printing module 304. In addition, the printer 104 in this embodiment further has a USB male connector 308, a storage unit 310, a card reader module 312, and a connection module 314, and all couples to the processing unit 302.

In the FIG. 3, the USB male connector 308 is coupled to the processing unit 302 through the USB cable 306 and configured for inserting into the USB port of the host apparatus 102, such as the USB port 212 or 214. Additionally, the storage unit 310 is probably a hard-disk driver or a flash memory. Furthermore, the card reader module 312 has a memory card slot 322 for containing a memory card, such like the memory card 324. In some embodiments, the memory card 324 is probably a PCMCIA card, a CF card, a SD card, a mini SD card, a micro SD card, a SDHC card, SDXC card, a T Flash card, a MMC card, a MMCplus card, a HC MMCplus card, a RS-MMC card, a MS card, a SM card, an xD card, a SDXC card, a MS XC card, or a Eye-Fi card. In this embodiment, the card reader module 312 is coupled to the process unit 302 via a pict-bridge interface 316.

In addition, the connection module 314 also has at least one connection port, such as the USB ports 332 and 334. Therefore, some peripheral devices can links with the printer 104 through the USB ports 332 and 334. In some embodiments, the peripheral devices comprise an external storage device 336 or a card reader 338. Wherein, the card reader 338 also has a memory slot 340 for containing a memory card, such as the memory card 342. The specification of the memory card 342 is probably the same as the memory card 324.

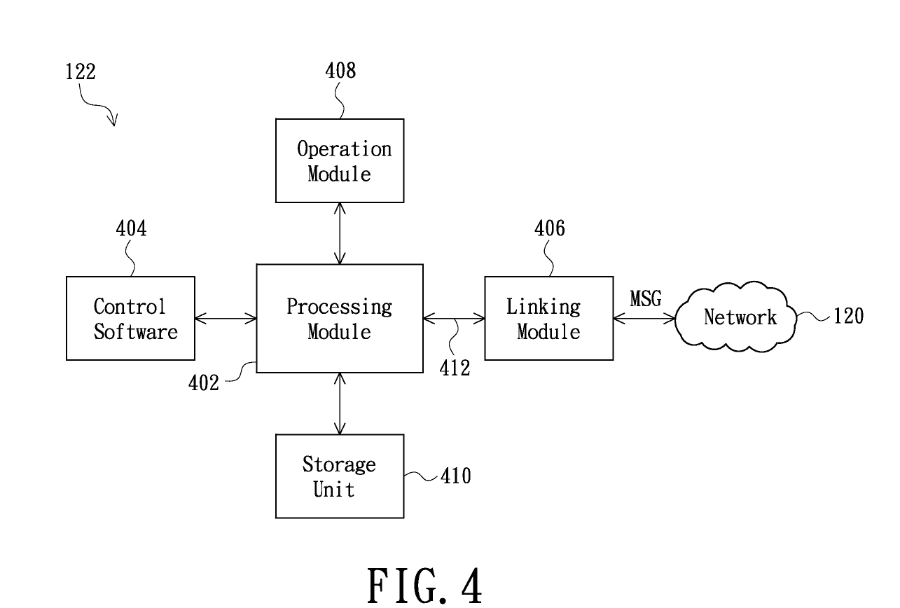

FIG. 4 is a schematic diagram of a mobile device according to one preferred embodiment of the present invention. Referring to the FIG. 4. The mobile device 122 comprises a processing module 402 and a control software 404. In this embodiment, the control software 404 can communicate with the control software 204 shown in the FIG. 2. Additionally, the processing module 402 can communicate with the control software 404.

In some embodiments, the mobile device 122 further has a linking module 406, an operation module 408, and a storage unit 410, which are coupled to the processing module 402. The linking module 406 links with the network 120 through a transmission interface 412, such like 3G interface, Wimax, LTE, TD-LTE, or WiFi. In addition, the operation module 408 has at least one operation unit, for example a real key, a touch-control panel, a joystick, a roll wheel, a trackball, etc. Furthermore, the storage unit 410 is probably a flash memory. In some embodiments, the control software 404 is saved in the storage unit 410.

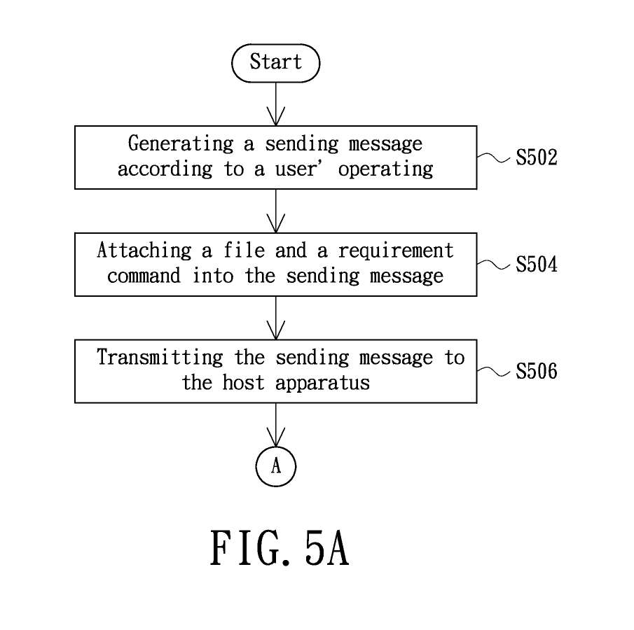

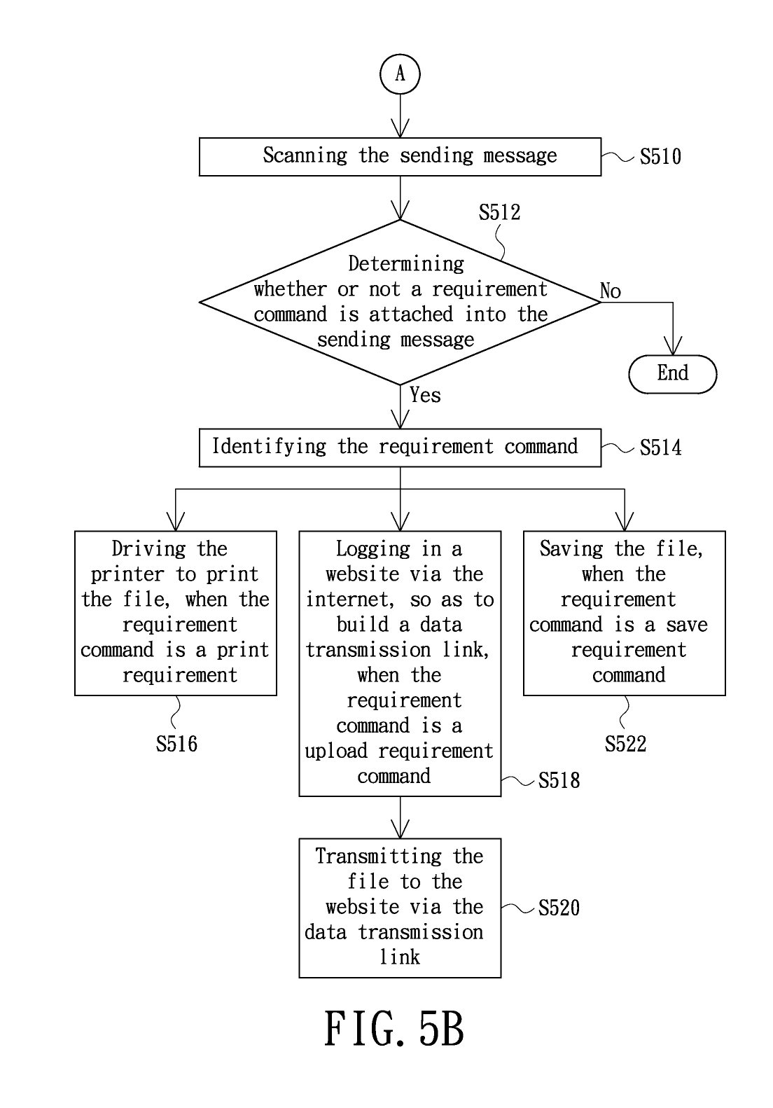

FIGS. 5A and 5B are a flow chart of a file management method according to one preferred embodiment of the present invention. Referring to the FIGS. 4 and 5A, first, in this exemplary embodiment, when the control software 404 is started, the control software 404 can performs the step S502 to generate a sending message MSG according to a user's operating through the operation module 408. In this embodiment, the sending message MSG is probably an e-mail. Meanwhile, the control software 404 can attach a file and a requirement command into the sending message MSG according to the user's operating, as the description in the step S504. Wherein, the file is probably a text file, an image file, a video file, or an audio file. Additionally, the requirement command is probably a predetermined string. Then, the control software 404 controls the processing module 402 transmitting the sending message MSG to the host apparatus 102 via the network 120, as description in the step S506.

Next, referring to the FIGS. 1, 2 and 5B, when the host apparatus 102 receives the sending message MSG, the control software 204, as the description in the step S510, would scan the sending message, so as to execute the step S512 to determine whether or not a requirement command is attached into the sending message MSG. When the requirement command is found in the step S512 (i.e., “Yes” labeled in the step S512), the control software 204 would identify the requirement command attached into the sending message MSG, as the description in the step S514.

For example, when the control software 204 checks that the requirement command is a print requirement command, the control software 204 would control the processing module 202 to generate a control command CTR_CMD. The control command CTR_CMD, then, is transmitted to the printer 104 from the connection module 212. In addition, the processing module 202 also transmits the file attached on the sending message MSG to the printer 104 through the data transmission interface 110.

Referring to the FIGS. 1, 2 and 3, when the control command CTR_CMD and the file are transmitted to the printer 104, the processing unit 302 would receive those through the USB male connector 308 and the USB cable 306. Meanwhile, the processing unit 302 controls the printing module 208 to print the file.

Additionally, if the control software 204 checks that the requirement command embedded into the sending message MSG is an upload requirement command, the control software 204 would control the host apparatus 102 to log in the website 124, as the description in the step S518, so as to build a data transmission link. Therefore, the control software 206 would control the host apparatus 102 uploading the file attached on the sending message MSG to the website 124 via the data transmission link. In the exemplary embodiment, the website 124 is a social group web site.

In addition, if the control software 204 checks that the requirement command attached into the sending message MSG is a save requirement command, the control software 204 would saves the file attached on the sending message MSG, as the description in the step S522. For example, the control software 204 would save the file into the internal storage unit 210. In other embodiments, the control software 204 would control the processing module 202 saving the file into the external storage device 106. Moreover, the control software 204 would control the processing module 202 generate the control command CTR_CMD to the printer 104, so as to save the file into the storage unit 310 in the printer 104 or the external storage device 336 connecting the USB port 332 of the printer 104.

In summary, because the present invention would attach a file on the sending message and embed a requirement command into the sending message, the file can be dealt according to the user's requirement. The process of dealing with the file is immediate.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for controlling a host apparatus, comprising:
scanning whether or not a requirement command is attached into a sending message, when the host apparatus receives the sending message, in which a file is attached;
identifying the requirement command, when the requirement command is found from the sending message; and
driving a printer connected to the host apparatus to print the file, when the requirement command is a print requirement command.

2. The method according to claim 1, further comprising:
logging in a website via the internet, when the requirement command is a upload requirement command; and
uploading the file to a website via the internet for responding the upload requirement command.

3. The method according to claim 1, further comprising:
saving the file, when the requirement command is a save requirement command attached into the sending message.

4. The method according to claim 3, wherein the step of saving the file comprises:
transmitting the file to a printer, so as to save the file into a storage unit configured on the printer.

5. The method according to claim 1, wherein the requirement command is a predetermined string.

6. The method according to claim 1, wherein the file is a text file, an image file, a video file, or an audio file.

7. The method according to claim 1, wherein the sending message is an e-mail.

8. A method for on-line printing, comprising:
generating a sending message according to an user's operating on a mobile device;
attaching a print requirement command and a file into the sending message; and
transmitting the sending message to a host apparatus from the mobile device, such that the host apparatus drives a printer to print the file in accordance with the print requirement command obtained through scanning the sending message.

9. The method according to claim 8, wherein the file is a text file, an image file, a video file, or an audio file.

10. The method according to claim 8, wherein the sending message is an e-mail.
